(19) United States
(12) Patent Application Publication
(10) Pub. No.: US 2014/0146525 A1
(43) Pub. Date: May 29, 2014

(54) Collapsible Illumination System

(71) Applicant: Hannah June Lueptow, Brooklyn, NY (US)

(72) Inventor: Hannah June Lueptow, Brooklyn, NY (US)

(21) Appl. No.: 14/093,317

(22) Filed: Nov. 29, 2013

Related U.S. Application Data
(60) Provisional application No. 61/730,745, filed on Nov. 28, 2012.

(51) Int. Cl. F21V 33/00

(52) U.S. Cl. CPC F21V 33/0008
USPC 362/103

(57) ABSTRACT

A collapsible illumination system consists of an expandable lamp shade compartment with an integrated solar-cell, battery, and LED in the flap of the shade. The solar cell charges the battery in daylight. In darkness the translucent lamp shade can be opened to diffuse the LED, which illuminates the space interior to the shade compartment. Reflective material within the lamp shade compartment enhances the illumination. The collapsible illumination system can be incorporated as part of clothing, bags, or other types of gear. Using a light colored shade provides lantern-like lighting for camping or other outdoor activity, while using a red or orange shade with a flashing LED provides extra visibility for pedestrians or cyclists.

### CROSS-REFERENCE TO RELATED APPLICATION

This application claims the benefit of U.S. Provisional Application No. 61/730,745 filed Nov. 28, 2012.

### BACKGROUND

1. Field of the Invention

The present invention relates to an illumination system that can be incorporated into wearable items such as backpacks, waistpacks, or clothing, as well as other outdoor articles. The lighting system can provide exterior illumination, interior illumination, or personal safety illumination.

2. Description of the Prior Art

As electronics have become smaller and lighter in weight, it has become possible to incorporate illumination systems in personal articles including backpacks and clothing for cyclist or pedestrian safety at night. For example, U.S. Pat. No. 5,836,671 describes a lighting arrangement for a backpack that includes an electro-luminescent strip on the exposed face of the backpack to enhance safety or for decorative purposes. More recently, U.S. Pat. No. 7,270,438 discloses a lighted backpack that incorporates a glowing cable borderline on the back of the backpack that is connected to an LED that is energized by a battery to provide an integrated safety illumination system for outdoor use by cyclists and pedestrians. U.S. Pat. No. 7,347,577 describes an electrical system for lighting backpacks and clothing that includes flashing lamps or LEDS for safety or novelty. U.S. Pat. No. 7,055,978 describes wearable items including backpacks or clothing with a flexible electroluminescent wire incorporated into the item making users visible and safe.

Other inventions have incorporated lighting systems in various personal items to provide illumination to the interior of the item or the nearby exterior of the item. An example is U.S. Pat. No. 6,824,291, which describes an electrical system and LED's for illuminating the interior of a pocketbook. U.S. Pat. No. 8,002,430 B2 discloses an illumination system that can be configured to illuminate the interior and/or exterior of a suitcase or backpack. U.S. Pat. No. 8,282,235 B2 describes a lighted workbag or backpack including an integrated, positionable light source at the end of a gooseneck that can be used to illuminate the interior or exterior of the backpack.

Still other inventions are aimed at lightweight, portable lanterns for camping, backpacking, or other use. For example, U.S. Pat. No. 6,685,337 discloses a combination flashlight/lantern for use in backpacking or other outdoor recreational use. U.S. Pat. No. 6,179,436 describes a system that converts a standard LED light source such as a flashlight into a lantern for backpacking. U.S. Pat. No. 6,290,367 discloses a solar powered lantern for outdoor work and leisure activities. More recently, U.S. Pat. No. 7,524,079 describes an alternative approach to a solar powered lantern.

### SUMMARY OF THE INVENTION

In one application of the present invention, an expanding and contracting lamp shade compartment is incorporated on the exposed front face of an otherwise typical backpack along with a small solar-powered LED light within the shade compartment. The battery powering the LED light charges during the daylight hours via a solar cell. When desired, the lamp shade portion can be opened to allow the LED light to be diffused by way of translucent side panels acting in a manner similar to a lamp shade to create a soft and dispersed light that can be used as a lantern for camping or safety illumination for pedestrians or cyclists. In the preferred embodiment a small solar cell is embedded on the exposed front face of the backpack to charge an embedded battery. The preferred embodiment uses white translucent ripstop nylon side panels to achieve the lampshade effect, but similar lightweight, translucent, and light colored fabrics or plastic could also be used. Inside of the lamp shade compartment, on the front interior panel of the compartment, a patch of reflective material such 3M® Scotchlite® can be used to maximize the LED's illuminating power, so that light diffusing through the translucent shade comes from both the LED light itself and from reflecting off of the reflective panel inside the shade compartment. When the LED light is not in use, the shade compartment can be folded up and secured with a plastic clip or similar device to the backpack allowing it to function as a normal backpack while the solar cell is charging the battery.

Another embodiment includes a flashing LED light and a red, yellow, or orange shade for pedestrian or cyclist safety and visibility.

### BRIEF DESCRIPTION OF THE DRAWINGS

FIG. 1 is a side view of a backpack incorporating the collapsible illumination system with the shade closed.

FIG. 2 is a side view of a backpack with the shade of the collapsible illumination system extended in its illumination position.

FIG. 3 is a view of the front face of the collapsible illumination system integrated into a backpack showing the solar cell charging system.

FIG. 4 is a front view of the collapsible illumination system of the present invention extended in its illumination position.

### DETAILED DESCRIPTION OF THE INVENTION

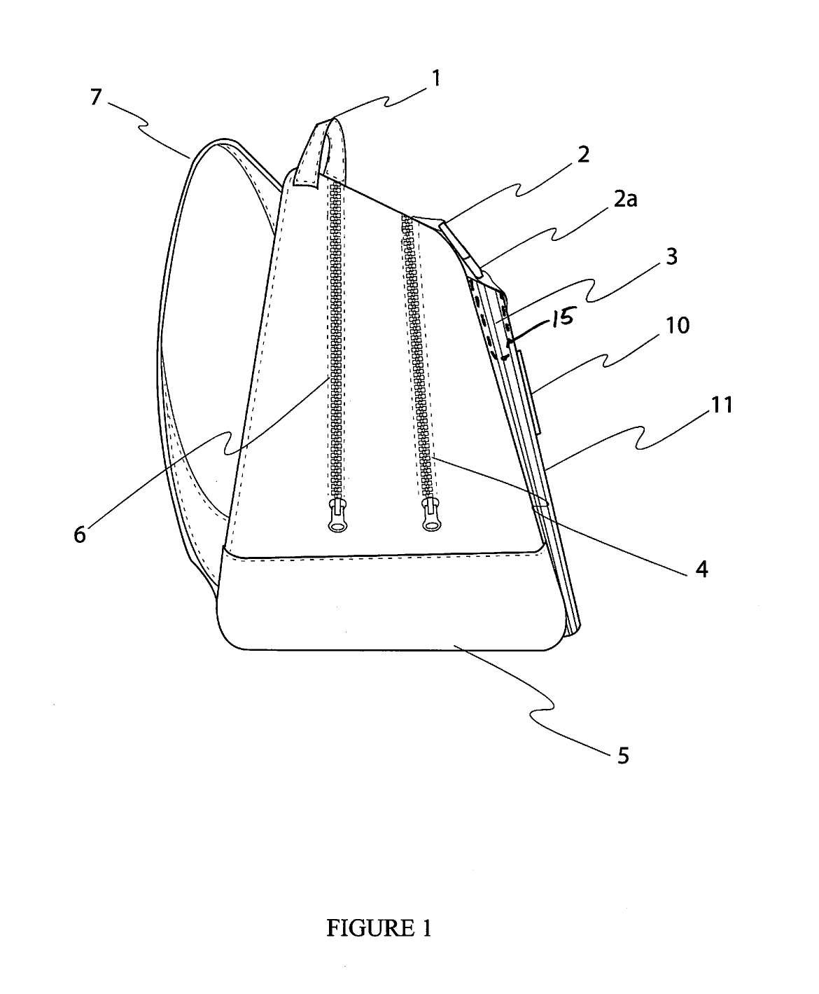

The preferred embodiment of this invention is showed in FIGS. 1-4. As shown in FIG. 1, the backpack incorporating the collapsible illumination system of the present invention has the typical elements of two shoulder straps 7, a handle 1, a base portion 5, and compartments with zipper closures 4 and 6. The backpack is made of a high strength fabric typical of backpacks such as a waterproof coated heavy duty nylon cordura. The illuminating lamp shade 3 of the invention is shown in the closed position and is secured with closure 2 such as a plastic clip, hook-and-loop material, or a zipper such that front panel 11 can be fixed in a closed position. The electronics assembly 10 is mounted on front panel 11.

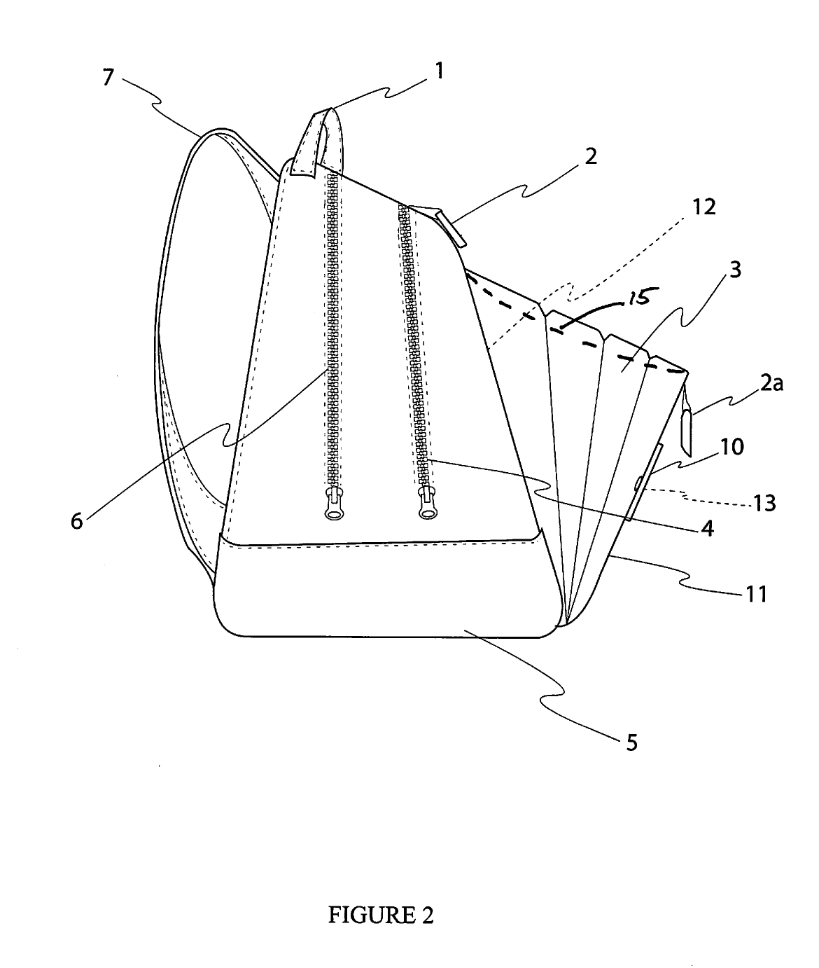

FIG. 2 shows a side view of a backpack incorporating the collapsible lighting device of the present invention with the illuminating lamp shade 3 in the open position with closure 2a detached from the mating closure 2 so that front panel 11 stretches the shade 3 to its full extent. An internal flexible connecting strut 15 may be added to assure that the shade 3 is fully extended; the strut, composed of a suitably flexible plastic material and biased in the open position, would bend to allow the illuminating lamp to be secured in the closed position. The shade 3 is typically made of a translucent or transparent material such as a light colored rip-stop nylon or translucent plastic. It can be fabricated in an accordion fashion so that it folds neatly in the closed position as shown in FIG. 1. The material of the illuminating shade 3 can be a specific color, such as a red translucent nylon or plastic for safety purposes or white for illumination while camping or other outdoor night activities. A shade compartment is formed by front panel 11, shade 3, and rear panel 12. Rear panel 12 on the interior of the compartment can comprise a highly reflective material such as 3M® Scotchlite®. This allows for a single LED light source 13 on the interior face of electronics package 10 to have maximum illuminating efficiency through the diffusion of light through shade 3, both from reflecting off of the rear panel 12 inside the shade compartment and directly from the LED light source 13 itself. Likewise, the interior of front panel 11 can also incorporate a surface of reflective material. Alternatively, rear panel 12 can be transparent or translucent material to allow illumination of the interior of one of the zippered compartments of the backpack.

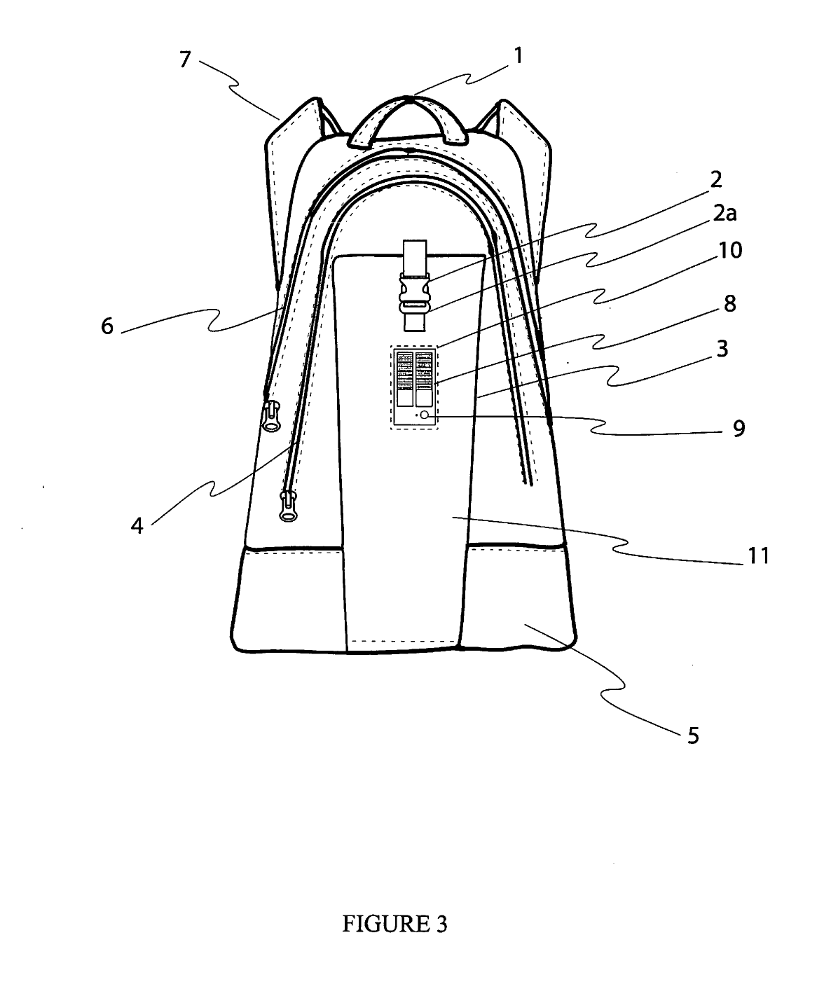

FIG. 3 shows the front view of a backpack incorporating the collapsible lighting device of the present invention with the shade 3 held in the closed position by securing front panel 11 with closure 2. Incorporated in front panel 11 is the electronics package 10 that consists of a solar cell 8 and a power button 9, as well as other components. Internal to electronics package 10 is a thin flat battery and the bright LED light source 13 (shown FIG. 2) facing the inside of the compartment formed by shade 3, as well as appropriate circuitry to control the electronics components. There is an opening in front panel 11 to allow LED 13 (shown in FIG. 2) to shine into the compartment formed by shade 3, thus illuminating the entire volume of the compartment within shade 3. One embodiment of the invention incorporates the LuminAID™ solar light. This component provides 4-6 hours of light and fully charges within 5 hours. The LuminAID™ package includes a push button switch, solar cell, charging indicator light when battery is charging, battery, and bright white LED on the opposite side of the solar cell in a single 6 cm by 12 cm by 0.5 cm thick flat electronics package. Those skilled in the art will appreciate that there are numerous other lighting systems that can be used as well. In the application of a backpack incorporating the collapsible lighting device of the present invention being used for camping with reference to FIGS. 2 and 3, during the day the solar cell 8 of the electronics assembly 10 gathers solar energy to charge the internal battery while front panel 11 is in the closed position. When lighting is required, front panel 11 can be opened to expose shade 3, and switch 9 can be used to turn on the LED 13 on the interior side of the electronics assembly 10 illuminating the interior compartment of shade 3 to provide diffused lantern-like illumination for reading or other activities. In the application for a pedestrian or cyclist, during the day the solar cell 8 of the electronics assembly 10 gathers solar energy to charge the internal battery while front panel 11 is in the closed position. At night front panel 11 can be opened to expose a red, yellow, or orange shade 3, and switch 9 can be used to turn on the LED 13 on the interior side of the electronics assembly 10 illuminating the interior compartment of shade 3 to provide highly visible safety illumination. The electronics assembly 10 can include a circuit to provide a strobe-like flashing of the LED 13 for additional visibility and safety.

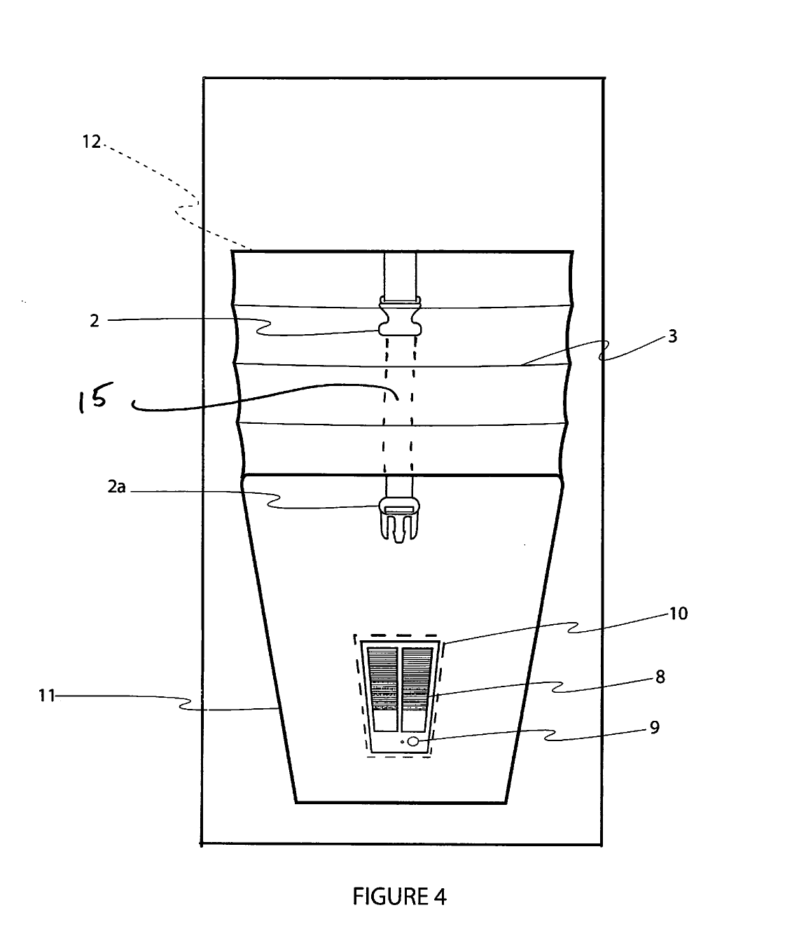

FIG. 4 is a front view of the collapsible illumination device of the present invention in the open position, without the addition of the backpack shown in FIGS. 1, 2, and 3. The rear panel 12 can be applied to a number of different devices depending on need. As shown in FIG. 4, the front panel 11, electronics assembly 10, shade 3, and clasp 2 and 2a can be used separately from the backpack. Also shown in FIG. 4 is the optional connecting strut 15. Alternative embodiments of the present invention include incorporating one or more of the shade 3, front panel 11, rear panel 12, and electronics assembly 10 elements in a wide variety of wearable articles such as reflective safety vests, waist-packs, outdoor clothing such as jackets, or novelty clothing. Likewise one or more of the shade 3, front panel 11, rear panel 12, and electronics assembly 10 elements of this invention could also be incorporated in a wide variety of outdoor or safety equipment such as bicycle panniers, camping duffel bags or tent bags, in the wall or fly of the tent itself, or safety items. As in the case of the backpack, the shade 3 would typically remain closed during daylight while the solar cell 8 is charging the battery and opened as needed in dark conditions to provide illumination through the shade 3 via the LED light 13.

Many variations of this invention are possible. For instance, the shade compartment, including shade 3, front panel 11, and rear panel 12, could alternatively be made of a flexible plastic with a resealable spout, like that in portable, collapsible water jugs, to allow the shade compartment of the device to be utilized for water storage as well as illumination. A variation of the invention would have the front panel 11 made of a translucent material to further expand the light diffusing properties of the backpack. In another variation, the LED light could be powered by a battery that is recharged using a typical transformer recharger instead of being recharged by a solar cell. Many other articles incorporating an expanding shade and light source can also be envisioned.

What is claimed is:

1. A collapsible lighting device comprising:
a front panel directly connected along one side to a rear panel;
a collapsible light-transmitting panel connected to said front panel and said rear panel;
at least one light source located on the interior of said front panel;
a power source for said light source;
a control system for said light source;
a fastening means capable of connecting said front panel to said rear panel in a closed position while maintaining said translucent panel in a collapsed state.

2. The collapsible lighting device of claim 1, wherein said light source comprises at least one light-emitting diode.

3. The collapsible lighting device of claim 1, wherein said power source comprises at least one solar charger and at least one battery.

4. The collapsible lighting device of claim 1, wherein said power source comprises an electrical generator and at least one battery.

5. The collapsible lighting device of claim 1, wherein said power source comprises an electrical generator and at least one capacitor.

6. The collapsible lighting device of claim 1, wherein said power source comprises a battery.

7. The collapsible lighting device of claim 1, wherein said control system is capable of powering said light on or off.

8. The collapsible lighting device of claim 1, wherein said control system is capable of powering said light on and off in a continuing sequence.

9. The collapsible lighting device of claim 1, wherein said rear panel is incorporated as part of a backpack.

10. The collapsible lighting device of claim 1, wherein said rear panel is incorporated as part of a bicycle pannier.

11. The collapsible lighting device of claim 1, wherein said rear panel is incorporated as part of a fabric structure.

12. The collapsible lighting device of claim 1, wherein said rear panel is incorporated as part of an article of clothing.

13. The collapsible lighting device of claim 1, further comprising at least one flexible connecting strut positioned between said front panel and said rear panel, said flexible connecting strut biased in the open position such that when said fastening means is not in use, the collapsible translucent panel is maintained in the substantially open position.

14. The collapsible lighting device of claim 1, further comprising a reflective material applied to the interior of said rear panel.

15. The collapsible lighting device of claim 1, wherein the interior portion of said rear panel is comprised of a light-reflective material.

16. The collapsible lighting device of claim 1, wherein said front panel, rear panel, and translucent side panel are connected together such that the volume defined thereby is watertight, and further comprising a resealable opening penetrating one of said panels such that liquid can be passed into and out of said lighting device.

17. The collapsible lighting device of claim 1, wherein said front panel is composed of a light-transmitting material.

18. The collapsible lighting device of claim 1, wherein said collapsible light-transmitting side panel is composed of a material that transmits light of a substantially single color.
